(19) United States
(12) Patent Application Publication
(10) Pub. No.: US 2008/0149422 A1
(43) Pub. Date: Jun. 26, 2008

(54) HUNTING STAND WITH TRANSFORMABLE SEAT ASSEMBLY

(76) Inventor: Chris Lott, Minneapolis, KS (US)

Correspondence Address: THOMPSON & THOMPSON, P.A., P.O BOX 166, SCANDIA, KS, 66966, US

(21) Appl. No.: 11/960,553

(22) Filed: Dec. 19, 2007

Related U.S. Application Data
(60) Provisional application No. 60/876,498, filed on Dec. 20, 2006.

(51) Int. Cl. A01M 31/02

(52) U.S. Cl. 182/187; 297/118

(57) ABSTRACT

A hunting stand for hunting includes a platform, a frame assembly extending above the platform and a transformable seat assembly supported by the frame assembly. The seat assembly includes first and second seat members supported for rotation about respective vertical axes. The first and second seat members are movable between a closed position in which the seat members are positioned close together to provide a seat at the center of the hunting stand, and an open position in which the seat members are positioned apart to provide a standing area at the center of the hunting stand. The hunting stand can be either a single-person stand or a two-person stand. In a two-person stand, the first and second seat members can be arranged to provide two spaced apart seats in respective corners of the stand for accommodating two people.

### RELATED APPLICATIONS

This application claims priority of U.S. Provisional Application No. 60/876,498 filed on Dec. 20, 2006. The content of this prior application is incorporated herein by reference.

### BACKGROUND OF THE INVENTION

1. Field of the Invention

The present invention relates generally to hunting stands. In particular, the present invention relates to hunting stands having seat assemblies that can be moved between a position that allows a hunter to sit and a position that allows a hunter to stand.

2. Description of the Related Art

Elevated stands for hunting are well known and widely used by hunters. A common hunting stand is the ladder stand, which includes a ladder having a lower end supported on the ground, and a platform supported at the top of the ladder and abutted against a tree. The ladder extends from the ground to the platform to allow the hunter to climb up to the platform. A seat assembly is normally provided above the platform to allow a hunter to be seated while hunting. The seat assembly includes a horizontal seat member, which is sometimes arranged to be folded up like a folding chair about a horizontal axis at the rear of the stand.

Existing seat assemblies for hunting stands cannot be conveniently moved completely out of the hunter's way when the hunter desires to stand on the platform instead of sit. Moreover, two-person hunting stands typically do not offer comfortable seating for both one and two persons.

Accordingly, there is a need in the industry for an improved seat assembly for hunting stands.

### SUMMARY OF THE INVENTION

A hunting stand for hunting includes a platform, a frame assembly extending above the platform and a transformable seat assembly supported by the frame assembly. The seat assembly includes first and second seat members supported for rotation about respective vertical axes. The first and second seat members are movable between a closed position in which the seat members are positioned close together to provide a seat at the center of the hunting stand, and an open position in which the seat members are positioned apart to provide a standing area at the center of the hunting stand. The hunting stand can be either a single-person stand or a two-person stand. In a two-person stand, the first and second seat members can be arranged to provide two spaced-apart seats in respective corners of the stand for accommodating two persons.

According to a broad aspect of the present invention, a seat assembly for a hunting stand is provided, comprising: first and second vertical frame members; a first seat member supported by the first vertical frame member for rotation about a first vertical axis; and a second seat member supported by the second vertical frame member for rotation about a second vertical axis. The first and second seat members are movable between a closed position in which the seat members are positioned close together to provide a seat at the center of the hunting stand, and an open position in which the seat members are positioned apart to provide a standing area at the center of the hunting stand.

According to another broad aspect of the present invention, a hunting stand is provided, comprising: a platform; a frame assembly extending above the platform; and a seat assembly supported by the frame assembly, the seat assembly comprising first and second seat members supported for rotation about respective vertical axes. The first and second seat members are movable between a closed position in which the seat members are positioned close together to provide a seat for the hunting stand, and an open position in which the seat members are positioned apart to provide a standing area for the hunting stand.

Numerous other objects and features of the present invention will be apparent to those skilled in this art from the following description wherein there is shown and described exemplary embodiments of the present invention, simply by way of illustration of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the present invention is made with reference to the accompanying drawings. In the drawings:

FIG. 1 is a perspective view of a single-person, ladder-type hunting stand having a seat assembly according to the present invention, with the seat members in their closed position.

FIG. 2 is a perspective view of the hunting stand shown in FIG. 1, with the seat members in their open position.

FIG. 3 is a plan view of the hunting stand according to the present invention with the seat members in their closed position.

FIG. 4 is a plan view of the hunting stand according to the present invention with the seat members in their open position.

FIG. 5 is a perspective view of two-person, ladder-type hunting stand having a seat assembly according to the present invention, with the seat members in their closed position.

FIG. 6 is a perspective view of the two-person hunting stand shown in FIG. 5, with the seat members in their open position.

FIG. 7 is another perspective view of the two-person hunting stand with the seat members in their open position.

FIG. 8 is a plan view of the two-person hunting stand with the seat members in their closed position.

FIG. 9 is a plan view of the two-person hunting stand with the seat members in their open position.

### DETAILED DESCRIPTION OF THE INVENTION

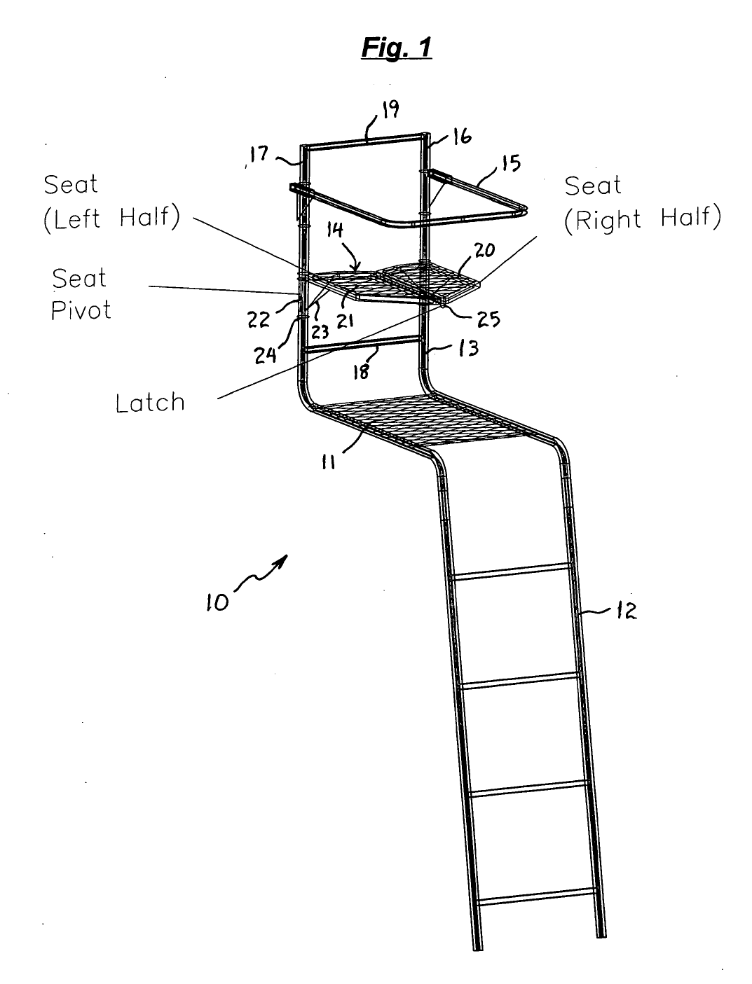

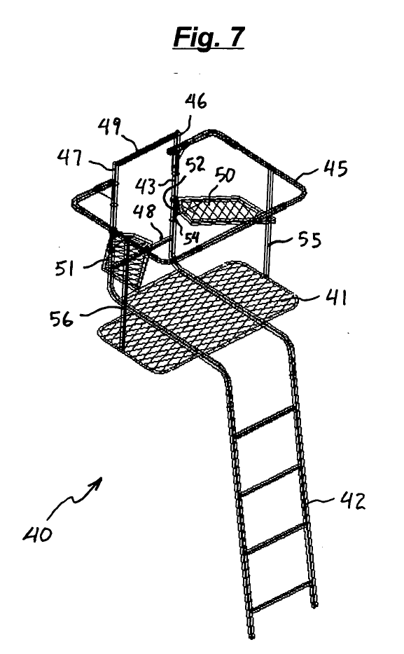

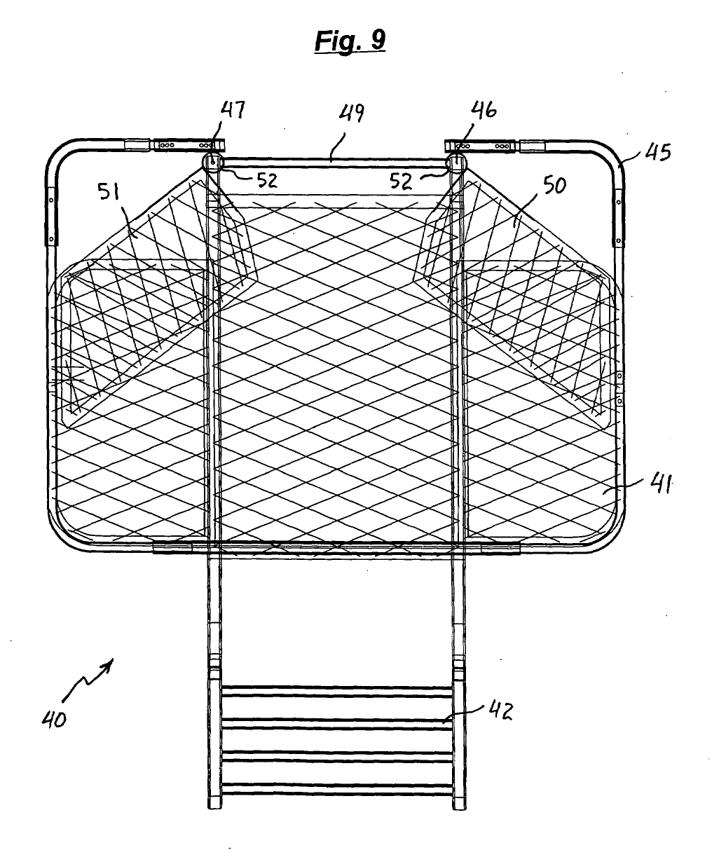

Embodiments of a hunting stand having a transformable seat assembly according to the present invention will now be described with reference to FIGS. 1 to 9 of the accompanying drawings.

A single-person hunting stand 10 according to the present invention is shown in FIGS. 1 to 4 of the drawings. The hunting stand 10 includes a platform 11, a ladder 12 extending downwardly from the platform 11, a frame assembly 13 extending above the platform 11, a seat assembly 14 supported by the frame assembly 13, and a guard rail 15 secured to the frame assembly 13 above the seat assembly 14.

The frame assembly 13 includes first and second vertical frame members 16, 17 located on respective right and left sides of the hunting stand 10. The vertical frame members 16, 17 can be formed of square tubing or other suitable structural members commonly used for hunting stands. A lower cross member 18 extends between the frame members 16, 17 near a lower end thereof, and an upper cross member 19 extends between the upper ends of the frame members 16, 17. The cross members 18, 19 provide structural rigidity to the frame assembly 13.

The seat assembly 14 includes a first seat member 20 supported by the first vertical frame member 16, and a second seat member 21 supported by the second vertical frame member 17. The first and second seat members 20, 21 are mounted to the respective first and second vertical frame members 16, 17 by tubular support members 22 that pivot about the vertical frame members 16, 17. Brace members 23 extend between the seat members 20, 21 and the tubular support members 22 to further brace and support the seat members 20, 21. Washers or other suitable abutment members 24 are secured to each of the vertical frame members 16, 17 below the tubular support members 22 to maintain the support members 22 at the desired height on the vertical frame members 16, 17. The first and second seat members 20, 21 are thus supported by the first and second vertical frame members 16, 17 for rotation about respective first and second vertical axes located on right and left sides of the center of the stand (i.e., the longitudinal axes of the vertical frame members 16, 17).

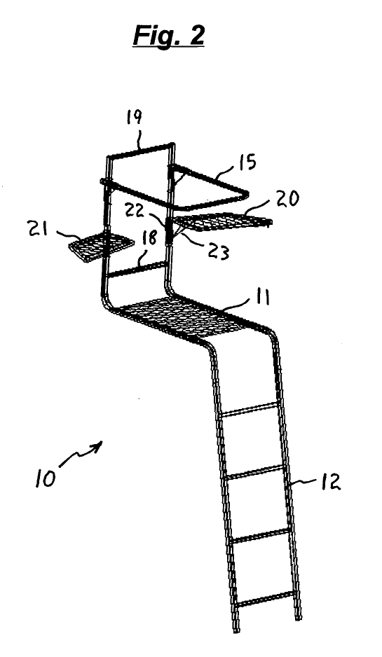

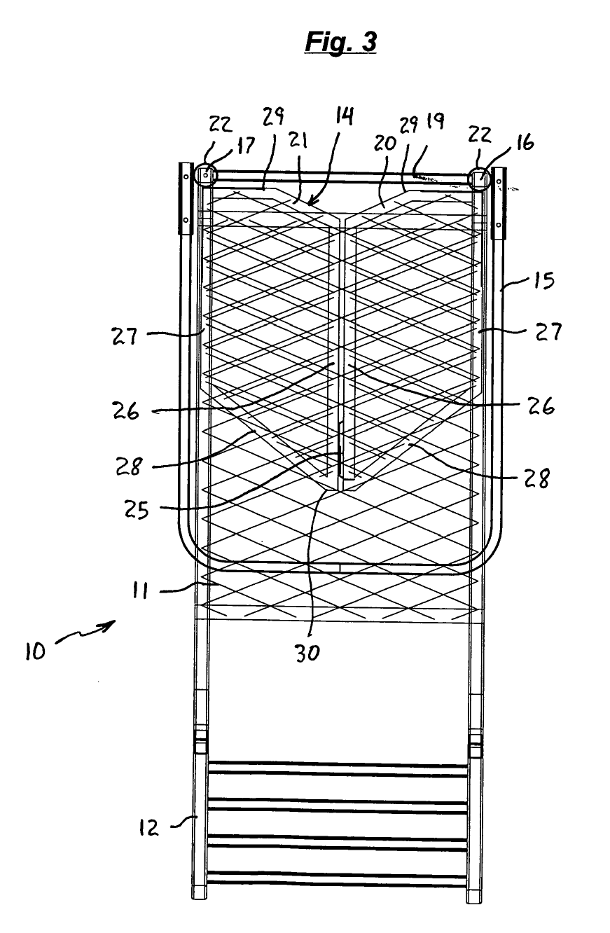

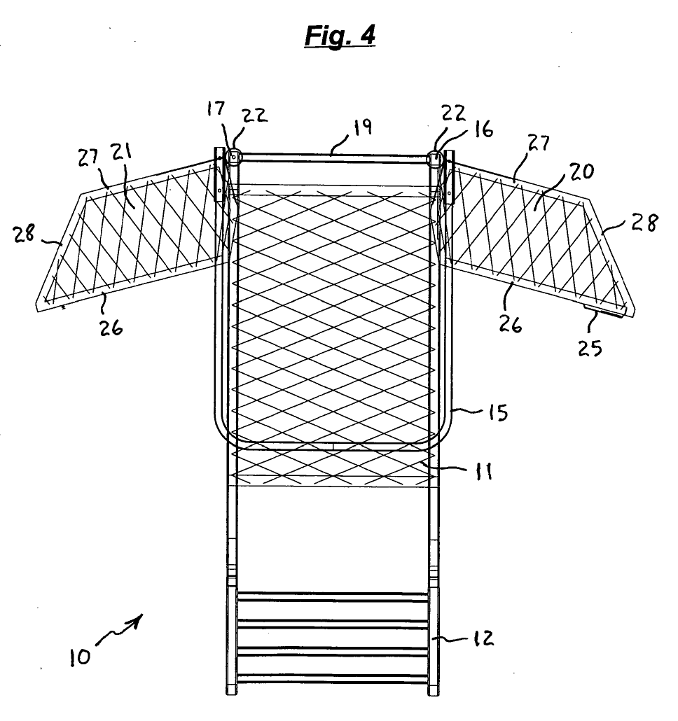

The first and second seat members 20, 21 are movable about the respective first and second vertical axes between a closed position (FIGS. 1 and 3) in which the seat members 20, 21 are positioned close together to provide a seat at the center of the hunting stand 10, and an open position (FIGS. 2 and 4) in which the seat members 20, 21 are positioned apart to provide a standing area at the center of the hunting stand 10. The seat members 20, 21 are movable between the closed and open positions by rotation in opposite directions relative to each other. As seen in FIGS. 3 and 4, the seat assembly 14 is substantially within a width of the guard rail 15 and the platform 11 in its closed position, and substantially outside a width of the guard rail 15 and the platform 11 in its open position. This arrangement ensures maximum comfort when the seat assembly 14 is used as a seat (FIG. 3), and maximum space and freedom to move within the confines of the platform 11 and the guard rail 15 when the seat assembly 14 is in its open position (FIG. 4).

A latch 25 is provided between the first and second seat members 20, 21 to secure the seat members 20, 21 together when both seat members are in their closed positions. The latch 25 can be any suitable structure, such as a hook and loop fastener or a pin connector.

As shown in the plan views of FIGS. 3 and 4, the seat members 20, 21 each comprises a polygonal shape in plan view, with first and second parallel sides 26, 27, a front side 28, and a rear side 29. The first parallel sides 26 are positioned side-by-side when the seat members 20, 21 are in their closed position, as shown in FIG. 3. The latch 25 is provided between the first parallel sides 26 to secure the seat members 20, 21 together.

The front sides 28 of the seat members 20, 21 extend between the respective front ends of the first and second parallel sides 26, 27 of each seat member 20, 21. The front sides 28 extend at an angle such that the seat has a protruding center portion 30 when the seat members 20, 21 are in their closed position.

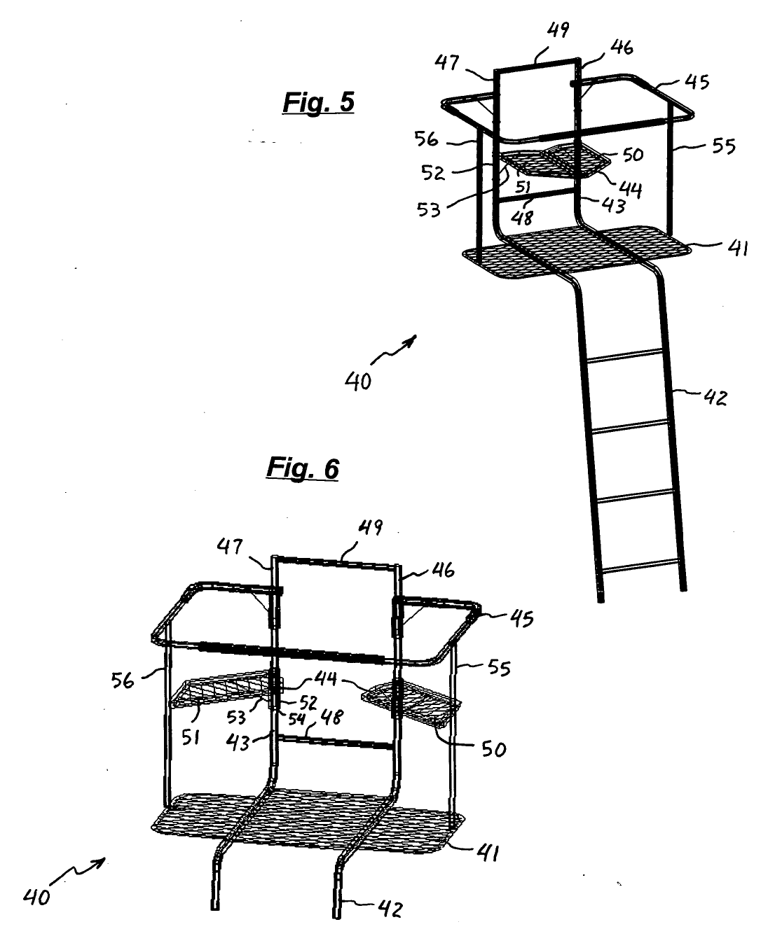

A two-person hunting stand 40 according to the present invention is shown in FIGS. 5 to 9. The two-person hunting stand 40 has a similar construction as the single-person hunting stand 10 described above. Specifically, the hunting stand 40 includes a platform 41, a ladder 42 extending downwardly from the platform 41, a frame assembly 43 extending above the platform 41, a seat assembly 44 supported by the frame assembly 43, and a guard rail 45 secured to the frame assembly 43 above the seat assembly 44.

The frame assembly 43 includes first and second vertical frame members 46, 47 located on respective right and left sides of the hunting stand 40. Upper and lower cross members 48, 49 provide structural rigidity to the frame assembly 43, as in the first embodiment described above.

The seat assembly 44 has basically the same structure as in the single-person embodiment described above. The first and second seat members 50, 51 are mounted to the respective first and second vertical frame members 46, 47 by tubular support members 52 that pivot about the vertical frame members 46, 47 for rotation about respective first and second vertical axes located on right and left sides of the center of the stand. Braces 53 and abutments 54 are also provided, similar to the first embodiment described above.

In the two-person hunting stand, the platform 41 and guard rail 45 are substantially wider to accommodate two people, instead of one. Vertical supports 55, 56 are used to help support the right and left sides of the guard rail 45 above the right and left sides of the platform 41. The vertical supports 55, 56 are also arranged to provide stops for limiting the outward pivoting of the seat members 50, 51 in their open position. For example, the vertical supports 55, 56 can be arranged to limit the outward rotation of the seat members 50, 51 about their respective vertical axes to approximately 30 to 60 degrees from their closed positions.

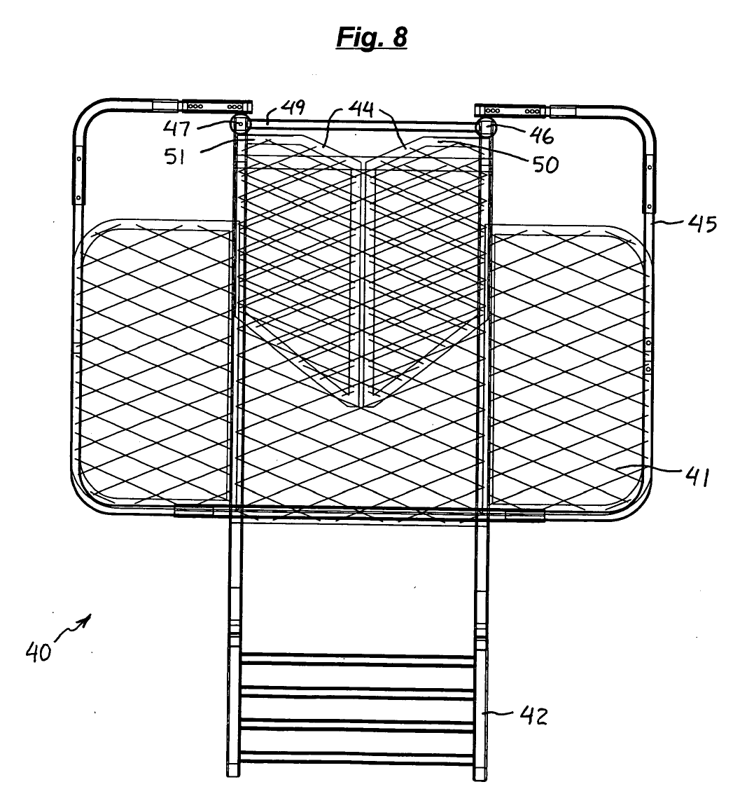

When the seat assembly 44 in the two-person hunting stand 40 is in its closed position, as shown in FIGS. 5 and 8, a seat is provided at the center of the hunting stand 40, and a single person can use the stand comfortably. When the seat assembly 44 is in its open position, as shown in FIGS. 6, 7 and 9, a standing area is provided at the center of the hunting stand 40, similar to the standing area in the single-person hunting stand 40 described above. The seat members 50, 51 are movable between their closed and open positions by rotation in opposite directions relative to each other.

The seat members 50, 51 in the open position also provide two spaced apart seats for accommodating two persons in the stand 40. Instead of a single bench seat across the back of the hunting stand as typically provided in two-person stands, the seat members 50, 51 in the present invention provide individual seats in the rear corners of the stand 40 facing in different directions. The individual seats improve the hunting stand as compared to a single bench seat by: (1) enhancing the comfort of the users; (2) making it easier for two people to communicate with each other while sitting in the stand; and (3) giving each person a different field of vision due to the different angles of the individual seats.

While the invention has been specifically described in connection with specific embodiments thereof, it is to be understood that this is by way of illustration and not of limitation, and the scope of the appended claims should be construed as broadly as the prior art will permit.

What is claimed is:

1. A seat assembly for a hunting stand, comprising:
first and second vertical frame members;
a first seat member supported by said first vertical frame member for rotation about a first vertical axis; and
a second seat member supported by said second vertical frame member for rotation about a second vertical axis, said first and second seat members being movable between a closed position in which the seat members are positioned close together to provide a seat at the center of the hunting stand, and an open position in which the seat members are positioned apart to provide a standing area at the center of the hunting stand.

2. The seat assembly according to claim 1, wherein said first and second seat members are mounted to the respective first and second vertical frame members by a tubular support member that pivots about said vertical frame members.

3. The seat assembly according to claim 1, wherein said hunting stand is a single person stand.

4. The seat assembly according to claim 1, wherein said hunting stand is a two-person stand, and wherein in said open position the seat members provide two spaced apart seats facing in different directions for accommodating two people.

5. The seat assembly according to claim 1, wherein said seat members each comprises a polygonal shape in plan view, said polygonal shape having first and second parallel sides, and said first parallel sides of the seat members are positioned side-by-side when the seat members are in their closed position.

6. The seat assembly according to claim 5, wherein said seat members each have a front side that extends between the first and second parallel sides, and wherein said front side extends at an angle such that the seat has a protruding center portion when the seat members are in their closed position.

7. A hunting stand, comprising:
a platform;
a frame assembly extending above the platform; and
a seat assembly supported by said frame assembly, said seat assembly comprising first and second seat members supported for rotation about respective vertical axes, said first and second seat members being movable between a closed position in which the seat members are positioned close together to provide a seat for the hunting stand, and an open position in which the seat members are positioned apart to provide a standing area for the hunting stand.

8. The hunting stand according to claim 7, wherein said frame assembly comprises first and second vertical frame members located on respective right and left sides of the hunting stand, and wherein said first and second seat members are mounted to the respective first and second vertical frame members by tubular support members that pivot about said vertical frame members.

9. The hunting stand according to claim 8, further comprising brace members that extend between said seat members and said tubular support members to brace the seat members during use.

10. The hunting stand according to claim 7, wherein said hunting stand is a single person stand.

11. The hunting stand according to claim 7, wherein said hunting stand is a two-person stand, and wherein in said open position the seat members provide two spaced apart seats facing in different directions for accommodating two people.

12. The hunting stand according to claim 7, wherein said seat members each comprises a polygonal shape in plan view, said polygonal shape having first and second parallel sides, and said first parallel sides of the seat members are positioned side-by-side when the seat members are in their closed position.

13. The hunting stand according to claim 12, wherein said seat members each have a front side that extends between respective front ends of the first and second parallel sides, and wherein said front side extends at an angle such that the seat has a protruding center portion when the seat members are in their closed position.

14. The hunting stand according to claim 7, further comprising a ladder extending downwardly from the platform.

15. The hunting stand according to claim 7, further comprising a guard rail secured to the frame assembly above said seat assembly.

16. The hunting stand according to claim 7, wherein a latch is provided between said first and second seat members to secure the seat members together when both seat members are in their closed positions.

17. The hunting stand according to claim 7, wherein said first and second seat members are movable between said closed and open positions by outward rotation of each of the seat members about respective vertical axes located on right and left sides of a center of the stand.

18. The hunting stand according to claim 17, further comprising stops for limiting further outward rotation of the first and second seat members in their open positions.

19. The hunting stand according to claim 17, wherein said first and second seat members are movable between said closed and open positions by rotating each of the seat members outwardly approximately 30 to 60 degrees about their respective vertical axes.

20. The hunting stand according to claim 7, wherein said seat provided by the first and second seat members in their closed position is located at a center of the stand, and said standing area provided by positioning the first and second seat members in their open position is located at the center of the stand.
